(19) United States
(12) Patent Application Publication
(10) Pub. No.: US 2020/0231816 A1
(43) Pub. Date: Jul. 23, 2020

(54) PHASE STABLE POLYMER-ASPHALT COMPOSITIONS

(71) Applicant: ExxonMobil Research and Engineering Company, Annandale, NJ (US)

(72) Inventors: Lyle E. Moran, Sarnia (CA); Lauren F. McKibben, Sarnia (CA); John A. Noel, Sarnia (CA)

(21) Appl. No.: 16/746,397

(22) Filed: Jan. 17, 2020

Related U.S. Application Data
(60) Provisional application No. 62/795,070, filed on Jan. 22, 2019.

(51) Int. Cl. C08L 95/00; C08J 3/24; C09D 195/00; C08J 3/20; E04D 5/02

(52) U.S. Cl. CPC C08L 95/00; C08J 3/242; C09D 195/00; C08J 2395/00; E04D 5/02; C08J 2453/00; C08L 2555/84; C08J 3/203

(57) ABSTRACT

Phase stable compositions of styrenic block copolymers (SBC) and high asphaltene content asphalts and methods for their preparation are provided. In particular the styrenic block copolymer is a styrene-conjugated diene-styrene block copolymer such as styrene-butadiene-styrene (SBS) and phase stability is achieved through addition of low levels of sulfur based crosslinkers. The compositions find use in, for example, the manufacture of roofing membranes.

This application claims priority to U.S. Provisional Application Ser. No. 62/795,070 filed Jan. 22, 2019, which is herein incorporated by reference in its entirety.

### FIELD

This disclosure relates to phase stable compositions of styrenic block copolymers (SBC) and high asphaltene content asphalts and to methods for their preparation. In particular the styrenic block copolymer is a styrene-conjugated diene-styrene block copolymer such as styrene-butadiene-styrene (SBS). The compositions find use in, for example, the manufacture of roofing to membranes. Accordingly, the disclosure further relates to a roofing membrane containing the compositions.

### BACKGROUND

Asphalt is a common material utilized for the preparation of roofing membranes and coatings. While the material is suitable in many respects, it is inherently deficient in some physical properties which would be highly desirable to improve. Efforts have been made in this direction by addition of certain conjugated diene rubbers, neoprene, resins, fillers and other materials for the modification of one or more of the physical properties of the asphalt binder. Each of these added materials modifies the asphalt in one respect or another but improvements to balance product performance are desired. For example, some of products have excellent weather resistance, sealing and bonding properties, but are often deficient with respect to warm tack, modulus, hardness and other physical properties.

Since the 1960s, styrene-butadiene rubber and styrene-rubber block copolymers, such as styrene-butadiene-styrene (SBS) and styrene-isoprene-styrene (SIS) block copolymers, have been used to dramatically improve the thermal and mechanical properties of asphalts. Practical application of the asphalt/co-polymer compositions requires that the blended product retain improved properties and homogeneity during transportation, storage and processing. Long term performance of co-polymer-modified asphalts also depends on the ability of the composition to maintain thermal and chemical stability.

Single-ply roofing membranes are fabricated from a base fabric impregnated with a flexible, waterproof polymeric material. The base fabric is typically felt, fiberglass, or polyester which imparts strength to the roofing membrane. The polymeric material may include asphalt, synthetic ethylene-propylene-diene monomer rubber (EPDM) or synthetic polymers such as polyvinylchloride (PVC) or styrenic block copolymers (SBC).

Optimum performance properties are achieved when the SBC and asphalt are compatible so as to provide a phase stable composition. Compatibility requires matching the appropriate asphalt in terms of asphaltenes content to the appropriate grade of SBC, usually a radial, star-shaped, high molecular weight SBS with significant chain entanglement. Practical application of the phase stable compositions requires that the composition retains properties and homogeneity during transportation, storage and processing.

Some asphalts have a relatively low asphaltenes content, for example, Alaska North Slope asphalt has an asphaltenes content of about 10% by weight. Such asphalts are quite suitable for membrane production as they are compatible with SBS copolymers so as to afford phase stable compositions. In contrast, heavier asphalts, such as those sourced from Western Canadian heavy crude, which have a relatively high asphaltenes content of from about 12 to about 18% by weight, are incompatible with SBS copolymers.

An asphalt single-ply roofing membrane typically contains about 5-10% by weight styrene-butadiene-styrene (SBS) block copolymer, 50-60% by weight asphalt and 30-40% calcium carbonate filler. The SBS content of the asphalt-polymer portion is typically about 12% SBS by weight.

It would be desirable to provide compatible, phase stable SBC/high asphaltene content asphalt compositions that may find use in, for example, roofing applications.

The reference in this specification to any prior publication (or information derived from it), or to any matter which is known, is not, and should not be taken as an acknowledgement or admission or any form of suggestion that the prior publication (or information derived from it) or known matter forms part of the common general knowledge in the field of endeavour to which this specification relates.

### SUMMARY

The present disclosure relates to novel phase stable asphalt-styrenic block copolymer compositions in which the asphalts have a high asphaltene content. The present disclosure further relates to roofing membranes comprising the novel compositions. The present disclosure also relates to a method of preparing kinetically stable compositions of styrenic block copolymers and high asphaltene content asphalts by using high shear mixing and sulfur based stabilizing or crosslinking agents.

It has been discovered that mild crosslinking with sulfur donors allows for the development of kinetically stable compositions comprising styrene block copolymers and high asphaltene containing asphalts, such as found in Western Canadian heavy crudes. The present disclosure enables the utilization of such heavy asphalts in roofing membrane production.

The advantages of the presently disclosed compositions may include one or more of quantity of additives used, compatibility with existing manufacturing processes and an ability to process a wide variety of asphalt feedstock.

In one aspect the present disclosure provides a phase stable polymer-asphalt composition, said composition comprising one or more styrenic block copolymers, one or more asphalts and one or more crosslinking agents, wherein the one or more asphalts has a total asphaltene content of greater than or equal to about 12% by weight.

In some embodiments the phase stable polymer-asphalt composition comprises from about 75 to about 99% by weight of one or more asphalts, from about 1 to about 20% by weight of one or more styrenic block copolymers and from about 0.01 to about 1.0% by weight of one or more cross-linking agents.

In some embodiments the total asphaltene content of the one or more asphalts is greater than or equal to about 13%, or greater than or equal to about 14%, or greater than or equal to about 15% by weight.

Preferably, the total asphaltene content of the one or more asphalts is greater than or equal to about 15% by weight.

In some embodiments the total asphaltene content of the one or more asphalts is from about 12% to about 25% by weight, or from about 13% to about 20% by weight, or from about 15% to about 20% by weight.

In some embodiments the phase stable polymer-asphalt composition comprises from about 2% to about 15% by weight of the one or more styrenic block copolymers.

Preferably, the styrenic block copolymers comprise polystyrene blocks.

Preferably, the styrenic block copolymers comprise a polybutadiene block.

In a preferred embodiment the phase stable polymer-asphalt composition comprises one or more styrene-butadiene-styrene (SBS) block co-polymers.

In some embodiments the cross-linking agent is elemental sulfur or a sulfur containing compound. In other embodiments the cross-linking agent is elemental sulfur or a sulfur containing compound suspended in a hydrocarbon oil.

In some embodiments the composition has a minimum softening point of 115° C., preferably 120° C.

The styrene block copolymer (SBC) may be a linear SBC, a radial SBC, or mixtures thereof. In some preferred embodiments the SBC comprises radial SBC.

In some preferred embodiments the styrene content of the SBS copolymer is from about 25 to about 40% by weight and the butadiene content is from about 60 to about 80% by weight.

In other preferred embodiments the styrene content of the SBS copolymer is from about 28 to about 32% by weight and the butadiene content is from about 68 to about 72% by weight

Preferably, the styrene block copolymer has a molecular weight from about 15,000 to about 550,000 Daltons, preferably from about 30,000 to about 420,000 Daltons.

In some embodiments the crosslinking agent is an agent capable of crosslinking SBC copolymers such as SBS copolymers.

In some embodiments the crosslinking agent is selected from elemental sulfur, polysulfides, particularly disulfides, and other agents capable of crosslinking SBS polymers, such as, for example, organic titanates and zirconates.

In some embodiments the crosslinking agent is suspended in a hydrocarbon oil.

The crosslinking agent may be present in an amount from about 0.01% to about 0.5% by weight based on the total weight of the composition, preferably from about 0.01% to about 0.3% by weight, more preferably from about 0.05% to about 0.2%.

In some preferred embodiments a mixture of elemental sulfur and polysulfide may be utilized. In a particularly preferred embodiment the crosslinking additive is selected from morpholine disulfide and elemental sulfur and mixtures thereof.

In another aspect the present disclosure provides a roofing composition comprising the phase stable polymer-asphalt composition according to any one of the herein disclosed embodiments and one or more fillers.

In some preferred embodiments the roofing composition comprises from about 1 to about 65% by weight filler added to harden or stiffen the composition and to decrease its cost.

The filler may be selected from the group of consisting calcium carbonate, limestone, chalk, ground rubber and mixtures thereof.

In some preferred embodiments the filler is calcium carbonate.

In some embodiments the roofing composition may comprise about 5-10% by weight styrenic block copolymer, 50-60% by weight asphalt and 30-40% by weight filler.

In some preferred embodiments the roofing composition may comprise about 5-10% by weight styrene-butadiene-styrene (SBS) block copolymer, 50-60% by weight asphalt and 30-40% by weight calcium carbonate filler.

In another aspect the present disclosure provides a roofing membrane comprising the roofing composition according to any one of the herein disclosed embodiments and one or more fabric substrates.

In some embodiments the fabric substrate is selected from felt, fiberglass or polyester.

In another aspect the present disclosure provides a method for making a phase-stable polymer-asphalt composition comprising, one or more asphalts, one or more styrenic block copolymers and one or more cross-linking agents, wherein the one or more asphalts have a total asphaltene content of greater than or equal to about 12% by weight, said method comprising:

(a) combining the one or more asphalts and one or more cross-linking agents; and

(b) adding the one or more styrenic block copolymers to the combination formed in (a).

In some embodiments the one or more asphalts are combined with the one or more cross-linking agents at a temperature from about 130 to about 200° C., preferably from about 150 to about 190° C.

In some embodiments after addition of the one or more styrenic block copolymers the resulting mixture is mixed under high shear at a temperature from about 160 to about 220° C., preferably from about 180 to about 200° C.

In some embodiments, after the high shear mixing, the mixture may be further mixed under low shear at a temperature from about 130 to about 210° C., preferably from about 150 to about 190° C.

In another aspect the present disclosure provides a method for making a roofing membrane comprising coating and/or saturating a fabric substrate with the phase stable polymer-asphalt composition according to any one of the herein disclosed embodiments.

Further features and advantages of the present disclosure will be understood by reference to the following drawings and detailed description.

### BRIEF DESCRIPTION OF THE DRAWINGS

FIG. 1 shows UV fluorescence microscopy photographs of a composition of SBS copolymer and low asphaltene content asphalt.

FIG. 2 shows UV fluorescence microscopy photographs of a composition of SBS copolymer and high asphaltene content asphalt.

FIG. 3 shows UV fluorescence microscopy photographs of a composition of SBS copolymer and high asphaltene content asphalt.

FIG. 4 shows UV fluorescence microscopy photographs of a composition of SBS copolymer and high asphaltene content asphalt.

FIG. 5 shows UV fluorescence microscopy photographs of compositions of SBS copolymers and high asphaltene content asphalt.

FIG. 6 shows UV fluorescence microscopy photographs of compositions of SBS copolymers and high asphaltene content asphalt with 0.1% crosslinking agent.

FIG. 7 shows UV fluorescence microscopy photographs of compositions of SBS copolymer and high asphaltene content asphalt with 0.2% crosslinking agent.

FIG. 8 shows UV fluorescence microscopy photographs of compositions of SBS copolymer and high asphaltene content asphalt with and without crosslinking agent.

FIG. 9 shows UV fluorescence microscopy photographs of a composition of SBS copolymer and high asphaltene content asphalt with and without crosslinking agent.

### DETAILED DESCRIPTION OF THE EMBODIMENTS

The following is a detailed description of the disclosure provided to aid those skilled in the art in practicing the present disclosure. Those of ordinary skill in the art may make modifications and variations in the embodiments described herein without departing from the spirit or scope of the present disclosure.

Although any methods and materials similar or equivalent to those described herein can also be used in the practice or testing of the present disclosure, the preferred methods and materials are now described.

It must also be noted that, as used in the specification and the appended claims, the singular forms ‘a’, ‘an’ and ‘the’ include plural referents unless otherwise specified. Thus, for example, reference to ‘asphalt’ may include more than one asphalts, and the like.

Throughout this specification, use of the terms ‘comprises’ or ‘comprising’ or grammatical variations thereon shall be taken to specify the presence of stated features, integers, steps or components but does not preclude the presence or addition of one or more other features, integers, steps, components or groups thereof not specifically mentioned.

Unless defined otherwise, all technical and scientific terms used herein have the meaning commonly understood by a person skilled in the art to which this disclosure belongs.

Unless specifically stated or obvious from context, as used herein, the term ‘about’ is understood as within a range of normal tolerance in the art, for example within two standard deviations of the mean. ‘About’ can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein in the specification and the claim can be modified by the term ‘about’.

Any methods provided herein can be combined with one or more of any of the other methods provided herein.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50.

Reference will now be made in detail to exemplary embodiments of the disclosure. While the disclosure will be described in conjunction with the exemplary embodiments, it will be understood that it is not intended to limit the disclosure to those embodiments. To the contrary, it is intended to cover alternatives, modifications, and equivalents as may be included within the spirit and scope of the disclosure as defined by the appended claims.

### High Asphaltene Compatibility

Heavy asphalts, such as asphalt found in Western Canadian heavy crude, are not suitable for typical SBS modification. For example, asphalt from Cold Lake, Canada has a high asphaltenes content making it inherently incompatible with radial SBS copolymers because of the competition between the asphaltenes and the radial SBS structure for dispersion by the non-asphaltenes portion of the asphalt.

Asphalt can be characterized through fractionation by liquid chromatography on an alumina column (ASTM D-4124) into four well-defined fractions. These are: n-heptane asphaltenes, saturates, naphthene-aromatics and polar aromatics. Upon treating asphalt with n-heptane, the asphaltenes, which are insoluble in n-heptane and precipitated. The resulting de-asphaltened fraction, referred to as maltenes, is loaded onto the alumina column. The saturates do not absorb on the alumina and are eluted with n-heptane. The naphthene-aromatics are absorbed on the alumina and subsequently desorbed with toluene. The polar aromatics are desorbed after the saturates and naphthene-aromatics using toluene and trichloroethylene eluents.

When about 12% SBS is added to Cold Lake asphalt, which has an asphaltenes content of about 15-18% by weight, it is the total of the asphaltenes and SBS molecules, ˜30% by weight in total, that the maltenes must disperse. However, the maltenes do not possess this solvent capability which leads to incompatibility. By comparison when about 12% by weight SBS is added to Alaska North Slope (ANS) asphalt, which contains about 10% by weight asphaltenes, the maltenes must disperse a much lower total amount. This results in a compatible composition.

The above is a somewhat simplified model of compatibility. More detailed models involve ratios of the various asphalt fractions, for example, asphaltenes/naphthene-aromatics (A/N), or (asphaltenes+polar aromatics)/naphthene-aromatics ((A+PA)/N). A target ratio for A/N is 0.6 maximum, or (A+PA)/N is <1.8. Cold Lake 150/200 penetration grade asphalt has an A/N ratio of 0.6 and a (A+PA)/N ratio of 2.2, that is, it does not achieve both criteria. By comparison, an Alaska North Slope (ANS) 150/200 penetration grade asphalt has an A/N ratio of 0.3 and a (A+PA)/N ratio of 1.4, that is, it achieves both criteria. This aligns with observed performance wherein SBS modified ANS asphalt is compatible and SBS modified Cold Lake asphalt is not compatible.

It should be understood that compatibility does not necessarily guarantee roofing membrane performance properties such as maximum softening point, elongation after aging and viscosity, especially once a filler, such as calcium carbonate is added to the mixture. But, without compatibility, the desired performance properties will not be achievable. It should also be understood, that compatibility can be measured by different means. Storage stability after 2 to 5 days at 163° C. is one measure. Also, the degree of asphalt dispersion in SBS as observed by fluorescence microscopy is another means. In the present disclosure fluorescence microscopic dispersion is utilized as the primary technique by which to evaluate the compatibility of asphalt-polymer compositions. This is based on the fact that storage stability is not a precise test and can be somewhat misleading, as situations may arise where a SBS modified asphalt with good storage stability is actually not compatible and vice versa. Furthermore, roofing membrane fabricators use SBS modified asphalt compositions within a few hours of preparation, rendering storage stability for 2 to 5 days somewhat less meaningful. On the other hand, these same fabricators use fluorescence microscopy as a quality control test to ensure that raw material selection and process conditions remain consistent in terms of compatibility.

### High Asphaltene Asphalt Grades

Asphalt roofing manufacturers generally use 180 to 200 penetration grade asphalt as their base asphalt, as this grade, at an SBS loading of from 10-15%, will give the desired membrane properties, provided it is compatible. There has been a trend over the last decade to broaden the base asphalt by blending asphalts.

### SBS Block Co-Polymers

The grade of styrene-butadiene-styrene block copolymer used in modified asphalt roofing membranes is predominantly a radial, high molecular weight SBS. The radial structure is required in order to achieve a minimum softening point (S.P.) and maximum engineering properties of the roofing membrane. The typical SBS grade contains 30% styrene and 70% butadiene. Exemplary grades include Kraton D 1101, LCY-161B (formerly Enichem T 161), Finaprene 411, Dexco 2411 and Solprene 411. Some roofing membrane manufacturers use a combination of radial and linear SBS copolymers. The addition of linear, lower molecular weight SBS lowers the processing viscosity but can also lower the maximum S.P. attainable.

### Crosslinking Agents

The crosslinking agent improves the compatibility of high asphaltene content asphalts with SBS polymers. Various cross-linking agents may be utilized, including elemental sulfur, polysulfides and other crosslinking agents. Combinations of crosslinking agents may be utilized and in some embodiments may provide advantageous synergism.

Useful crosslinking agents include many of those utilized in the rubber industry.

For example, crosslinking agents include, but are not limited to, disulfides such as morpholine disulphide, tetraethyl thiuram disulphide, N, N, N′, N′-tetraisobutyl thiuram disulphide and dialkylsulfides, epoxy modified polysulfides, elemental sulfur and organic titanates and zirconates.

The amount of crosslinking agent may be in the range from about 0.01% to about 1% based on the total weight of the composition, preferably from about 0.02 to about 0.5%, more preferably from about 0.02 to about 0.3%.

In one embodiment the present disclosure provides a phase stable polymer-asphalt composition, said composition comprising one or more styrenic block copolymers, one or more asphalts and one or more crosslinking agents, wherein the one or more asphalts has a total asphaltene content from about 12% to about 25% by weight, preferably from about 15% to about 20% by weight;

wherein the styrenic block copolymer is a styrene-butadiene-styrene copolymer; and
wherein the crosslinking agent is present in amount from about 0.02% to about 0.5% by weight based on the total weight of the composition.

In another embodiment the present disclosure provides a phase stable polymer-asphalt composition, said composition comprising one or more styrenic block copolymers, one or more asphalts and one or more crosslinking agents,

wherein the one or more asphalts has a total asphaltene content from about 12% to about 25% by weigh, preferably from about 15% to about 20% by weight;
wherein the styrenic block copolymer is a styrene-butadiene-styrene copolymer; and
wherein the crosslinking agent is selected from the group consisting of elemental sulfur, disulfides and mixtures thereof and the total amount of crosslinker is from about 0.02% to about 0.5% by weight based on the total weight of the composition.

In another embodiment the present disclosure provides a phase stable polymer-asphalt composition, said composition comprising one or more styrenic block copolymers, one or more asphalts and one or more crosslinking agents,

wherein the one or more asphalts has a total asphaltene content from about 12% to about 25% by weigh, preferably from about 15% to about 20% by weight;
wherein the styrenic block copolymer comprises a radial styrene-butadiene-styrene copolymer; and
wherein the crosslinking agent is selected from the group consisting of elemental sulfur, disulfides and mixtures thereof and the total amount of crosslinker is from about 0.02% to about 0.5% by weight based on the total weight of the composition.

In another embodiment the present disclosure provides a phase stable polymer-asphalt composition, said composition comprising one or more styrenic block copolymers, one or more asphalts and one or more crosslinking agents,

wherein the one or more asphalts has a total asphaltene content from about 12% to about 18% by weight, preferably from about 15% to about 18% by weight;
wherein the styrenic block copolymer comprises a radial styrene-butadiene-styrene copolymer; and
wherein the crosslinking agent is selected from the group consisting of elemental sulfur, disulfides and mixtures thereof and the total amount of crosslinker is from about 0.02% to about 0.5% by weight based on the total weight of the composition.

In another embodiment the present disclosure provides a phase stable polymer-asphalt composition, said composition comprising one or more styrenic block copolymers, one or more asphalts and one or more crosslinking agents,

wherein the one or more asphalts has a total asphaltene content from about 12% to about 25% by weigh, preferably from about 15% to about 20% by weight;
wherein the styrenic block copolymer comprises a radial styrene-butadiene-styrene copolymer; and
wherein the crosslinking agent is selected from the group consisting of elemental sulfur, morpholine disulfide and mixtures thereof and the total amount of crosslinker is from about 0.02% to about 0.5% by weight based on the total weight of the composition.

In another embodiment the present disclosure provides a roofing composition comprising a phase stable polymer-asphalt composition and from about 1 to about 65% by weight fillers, said phase stable polymer-asphalt composition comprising one or more styrenic block copolymers, one or more asphalts and one or more crosslinking agents,

wherein the one or more asphalts has a total asphaltene content from about 12% to about 25% by weight, preferably from about 15% to about 20% by weight;
wherein the styrenic block copolymer is a styrene-butadiene-styrene copolymer; and
wherein the crosslinking agent is present in an amount from about 0.02% to about 0.5% by weight based on the total weight of the phase stable polymer-asphalt composition.

In another embodiment the present disclosure provides a roofing composition comprising a phase stable polymer-asphalt composition and from about 1 to about 65% by weight fillers, said phase stable polymer-asphalt composition comprising one or more styrenic block copolymers, one or more asphalts and one or more crosslinking agents,

wherein the one or more asphalts has a total asphaltene content from about 12% to about 25% by weigh, preferably from about 15% to about 20% by weight;
wherein the styrenic block copolymer is a styrene-butadiene-styrene copolymer; and
wherein the crosslinking agent is selected from the group consisting of elemental sulfur, disulfides and mixtures thereof and the total amount of crosslinker is from about 0.02% to about 0.5% by weight based on the total weight of the phase stable polymer-asphalt composition.

In another embodiment the present disclosure provides a roofing composition comprising a phase stable polymer-asphalt composition and from about 1 to about 65% by weight fillers, said phase stable polymer-asphalt composition, comprising one or more styrenic block copolymers, one or more asphalts and one or more crosslinking agents,

wherein the one or more asphalts has a total asphaltene content from about 12% to about 25% by weigh, preferably from about 15% to about 20% by weight;
wherein the styrenic block copolymer comprises a radial styrene-butadiene-styrene copolymer; and
wherein the crosslinking agent is selected from the group consisting of elemental sulfur, disulfides and mixtures thereof and the total amount of crosslinker is from about 0.02% to about 0.5% by weight based on the total weight of the phase stable polymer-asphalt composition.

In another embodiment the present disclosure provides a roofing composition comprising a phase stable polymer-asphalt composition and from about 1 to about 65% by weight fillers, said phase stable polymer-asphalt composition comprising one or more styrenic block copolymers, one or more asphalts and one or more crosslinking agents,

wherein the one or more asphalts has a total asphaltene content from about 12% to about 18% by weigh, preferably from about 15% to about 18% by weight;
wherein the styrenic block copolymer comprises a radial styrene-butadiene-styrene copolymer; and
wherein the crosslinking agent is selected from the group consisting of elemental sulfur, disulfides and mixtures thereof and the total amount of crosslinker is from about 0.02% to about 0.5% by weight based on the total weight of the phase stable polymer-asphalt composition.

In another embodiment the present disclosure provides a roofing composition comprising a phase stable polymer-asphalt composition and from about 1 to about 65% by weight fillers, said phase stable polymer-asphalt composition comprising one or more styrenic block copolymers, one or more asphalts and one or more crosslinking agents,

wherein the one or more asphalts has a total asphaltene content from about 12% to about 25% by weigh, preferably from about 15% to about 20% by weight;
wherein the styrenic block copolymer comprises a radial styrene-butadiene-styrene copolymer; and
wherein the crosslinking agent is selected from the group consisting of elemental sulfur, morpholine disulfide and mixtures thereof and the total amount of crosslinker is from about 0.02% to about 0.5% by weight based on the total weight of the phase stable polymer-asphalt composition.

In any one of the above disclosed embodiments the filler may be selected from the group consisting of calcium carbonate, limestone, chalk, ground rubber and mixtures thereof.

In some preferred embodiments the filler is calcium carbonate.

There is also provided a roofing membrane comprising the roofing composition according to any one of the herein disclosed embodiments and one or more fabric substrates.

In some embodiments the fabric substrate is selected from felt, fiberglass or polyester

### Examples

### Materials

The following asphalts were utilized in the examples. An Alaska North Slope asphalt having a penetration grade of 150/200, a Cold Lake asphalt having a penetration grade of 150/200, a Cold Lake asphalt having a penetration grade of 300/400, a Cold Lake-based Roofing Asphalt Flux (ex Nanticoke refinery) having a penetration grade of 300/400 and Nanticoke PG 58-28 asphalt.

Three SBS polymers, LCY-161B (ICY′) from LCY Elastomers, Solprene 411 (′Solprene) from Dynasol, and Luprene 411 (‘Luprene’) from LG Chemical were utilized. These each contain approximately 30% styrene and 70% butadiene.

The following crosslinking agents were used for most of the tests. X-23002 which is a morpholine disulfide additive supplied by Kao Specialties Americas LLC, AKROCHEM ACCELERATOR R which is a morpholine disulfide additive sold by Akrochem Corporation, and Hexlink 518 which is a 50% active dispersion of sulfur in napthenic oil sold by Hexpol Coumpounding. Sulfur was tested as AKROFORM SULFUR PM (80) also available from Akrochem Corporation.

### Softening Points

Compatibility of polymer-asphalt compositions was initially assessed by storing the compositions for 5 days at 163° C. in 100 mm diameter 1 litre containers and examining the degree of SBS stratification if separation from the asphalt occurred. The use of smaller diameter containers yields misleading data as the cohesiveness of the SBS polymer and its adhesion to the walls of the narrower containers interferes with the separation. Following a cooling period, the top and bottom parts were separated by cutting the containers in half. Softening Points (S.P.) were measured on each part and a Storage Stability ratio (S.P. top/S.P. bottom) calculated. An acceptable range for the Storage Stability ratio is 0.9 to 1.1. Other measures can be used in place of Softening Point (S.P.) ratios such as the difference in S.P. (° C.), dynamic shear rheometry (DSR), or viscosity ratios. However, they are all relatively equivalent and afford similar conclusions.

### UV Fluorescence Microscopy

UV fluorescence microscopy is a widely used technology for assessing the compatibility of SBS modified asphalts. This is based on the emission of energy that occurs in the presence of UV radiation as a result of the excitation of the double bonds present in the butadiene portion of the SBS molecule. A digital imaging acquisition system combined with UV fluorescence microscopy was used in combination with macroscopic techniques including visual inspection and softening point ratio (top/bottom) to assess the compatibility of SBS polymer modified asphalts for both paving and roofing applications.

The digital image acquisition system consisted of a binocular optical microscope fitted with a 100 W mercury short arc DC power source, a high resolution digital camera and image processing software. The image acquisition analysis was explicitly qualitative in nature, however, a micron bar was applied to each image along with relevant calibration information.

During slide preparation the cover slip was carefully adjusted to ensure that a level surface was created with respect to the underlying slide. This ensured that the maximum amount light emitted from the sample was captured by the optical components of the microscope thus optimizing image resolution and clarity.

Compatibility is a function of the SBS dispersion in the asphalt. Following the storage stability period, the sample is divided into a top and bottom portion from which slides are prepared. Compatibility is assessed by comparing the SBS dispersion in the two slides, such that, the closer they resemble each other the greater the compatibility of the sample.

There is an inherent degree of subjectivity involved in assessing SBS compatibility based on UV fluorescence microscope images, however some guidelines have been followed that allow for a reliable evaluation from sample to sample. A phase inversion occurs when 12% SBS is blended into asphalt. The asphalt becomes dispersed in the SBS, and the SBS becomes the continuous phase. In other words, the properties of the SBS modified asphalt are controlled or expressed by the SBS phase. In fluorescence microscopy, the SBS fluoresces green/yellow and the asphalt phase remains black allowing one to visually observe the degree of SBS dispersion or compatibility. Good compatibility typically appears as finely striated network of alternating bands of polymer and asphalt similar to the appearance of wood grain, as many small dots of polymer interspersed with small dots of asphalt or as a combination thereof. Excellent compatibility often appears as a continuous greenish-yellow haze often similar in appearance to wet beach sand. Poor compatibility is characterized by large isolated globs or bands of polymer in a predominantly black asphalt background.

### Preparation of Compositions

Blends of the asphalts with SBS polymer were prepared by mixing in a high-shear mixer at ˜5000 rpm for 30 minutes at a temperature of 180-200° C., followed by low-shear mixing to for 4 hours at 150-180° C. The level of SBS addition was 12% by weight.

For most tests, the crosslinking agent (when used) was first added to the asphalt at about 150-190° C. before adding the SBS.

The 5-day storage stability test was shortened to 2 days in order to accelerate the compatibility screening of SBS modified Cold Lake asphalt blends with a variety of cross-linking additives for a range of asphalt penetration grades. Table 1 shows the comparison of the 2 and 5-day storage stability tests for various SBS modified Cold Lake asphalts and Alaska North Slope asphalt. The conclusion was that the 2-day test was as accurate as the 5-day test. As a result, all subsequent experiments were performed using the 2-day test. Note that the data in Table 1 show that the Storage Stability test is not always accurate, especially for the softer 300/400 penetration grade asphalt versus the 150/200 penetration grade asphalt. The storage stability data for the 150/200 penetration grade asphalt (Example 2) fails at both 2 and 5-days matching the fluorescence microscopy incompatibility rating. In contrast, the 2 and 5-day storage stability data for 300/400 penetration grade asphalt (Example 3), pass and do not match the fluorescence microscopy borderline incompatibility rating. For this reason, storage stability ratings by softening point ratios are considered a general guide as opposed to an absolute certainty and should always be supported by fluorescence microscopy. The results in Table 1 show that low asphaltene content North Slope asphalt is compatible with SBS yielding a phase stable composition whereas the Cold Lake asphalts which have high asphaltene contents are not compatible with SBS and yield compositions which are not phase stable.

TABLE 1

| | | | Storage | | | |
|---|---|---|---|---|---|---|
| | Asphalt or | Asphaltene | stability | | | Fluorescence |
| Example | Asphalt/polymer | content | S.P. top/bottom | | | Microscopy |
| No. | Source | (wt. %) | 2-Day | 5-day | S.P. ° C. | Compatible |
| 1 | Alaska North | <3 | 0.965 | 0.933 | 135.9 | Yes |
| | Slope | | | | | |
| | 150/200 | | | | | |
| 2 | Cold Lake | 15-18 | 1.58 | 1.34 | 122.7 | No |
| | 150/200 | | | | | |
| 3 | Cold Lake | 15-18 | 1.02 | 1.01 | 120.2 | No |
| | 300/400 | | | | | |
| 4 | Nanticoke Cold | 15-18 | 0.99 | 1.1 | 124.6 | No |
| | Lake RAF | | | | | |
| | 300/400 | | | | | |

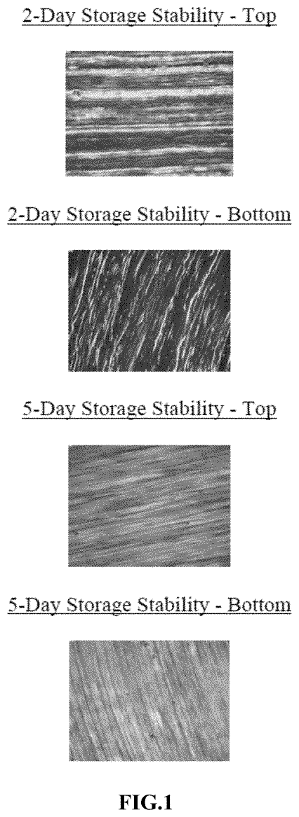

FIGS. 1 to 4 show fluorescence microscopy photographs of compatible and incompatible SBS modified asphalts including Alaska North Slope and various Cold Lake asphalts. The Figures are as follows:

FIG. 1: Alaska North Slope 150/200

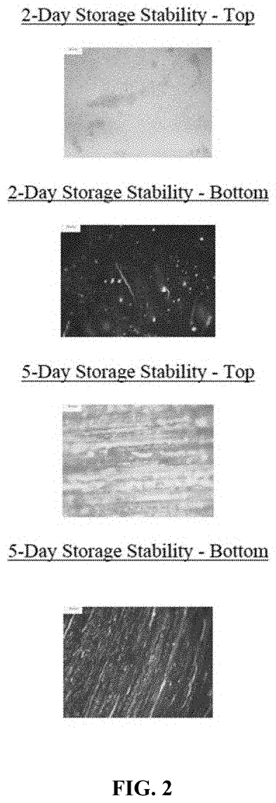

FIG. 2: Cold Lake 150/200

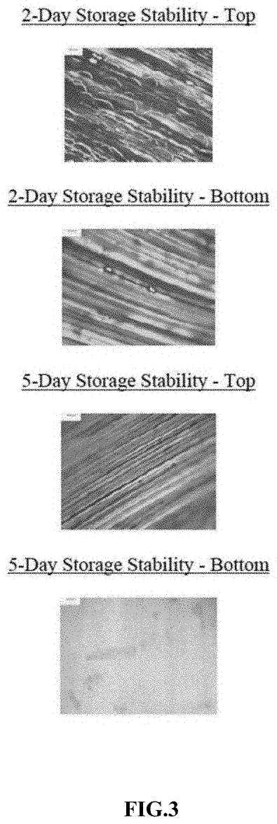

FIG. 3: Cold Lake 300/400

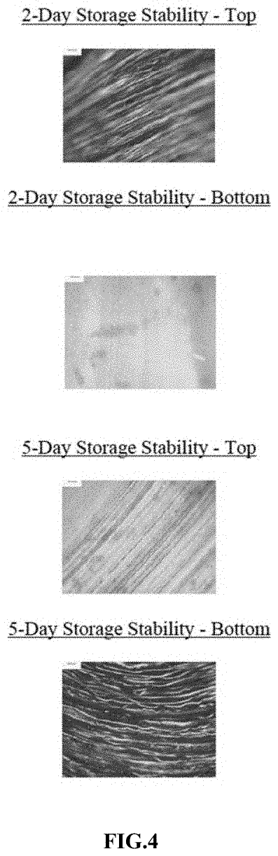

FIG. 4: Nanticoke Cold Lake RAF 300/400

As can be seen, for the blend that is compatible (FIG. 1) the top and bottom phases have a similar, well blended structure, whereas the top and bottom phases for the blends that are incompatible look quite different (FIGS. 2 to 4). The top phase is generally very smooth looking and well blended with strong SBS fluorescence which represents the fact that the SBS has predominantly floated to the top. The bottom phase is generally very separated looking with discrete phases of SBS fluorescence and black asphalt phases which represents the fact that the asphalt is predominantly in the bottom phase.

Further, the good compatibility of Alaska North Slope gives a maximum Softening Point (S.P.) of approximately 135° C. versus 120° C. for Cold Lake. This difference of about 15° C. is what can occur if compatibility is achieved by molecular composition of the asphalt which allows the SBS co-polymer to achieve its optimum molecular configuration for maximum engineering properties. Alaska North Slope has a low asphaltenes content and the maltenes have enough dispersing properties to stabilize the SBS molecules.

The photographs in FIGS. 1 to 4 were used as reference standards with which to compare the various additized SBS modified Cold Lake asphalts. Table 1 contains the Storage Stability measurements for the SBS modified asphalts shown in FIGS. 1 to 4 as well as the compatibility rating. Fluorescence microscopy was used to confirm the degree of compatibility and the Storage Stability ratios were used only as a guide.

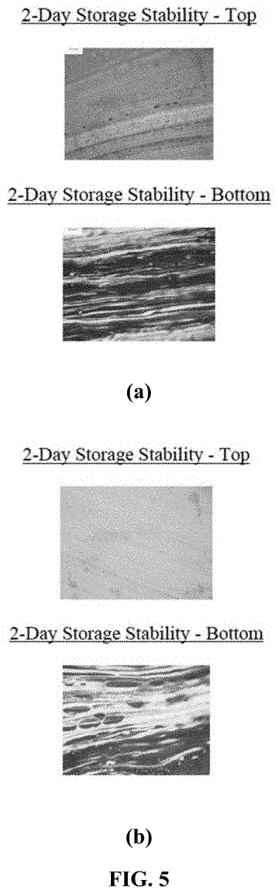

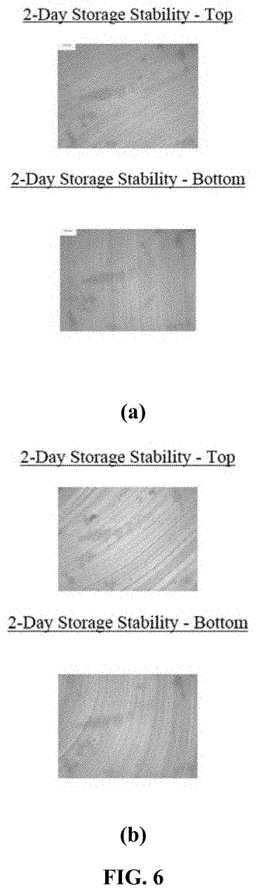

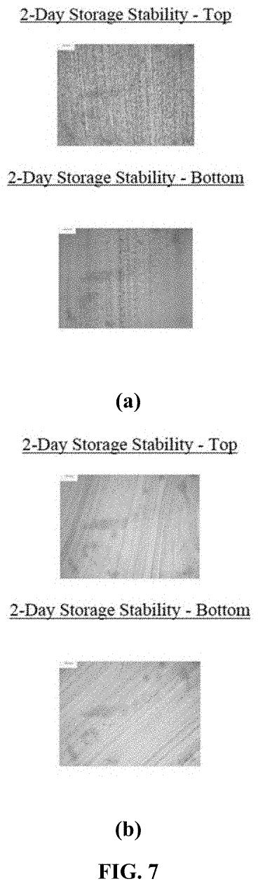

Comparative experiments were conducted to show that LCY and Solprene SBS copolymers give similar asphalt compatibility results. The results are given in Table 2. FIGS. 5 to 7 show the fluorescence microscope photographs of LCY and Solprene modified Cold Lake RAF with and without cross-linking additives. FIGS. 5a and 5b (respectively Examples 5 and 6) show the photographs for non-crosslinked LCY and Solprene. FIGS. 6a and 6b (respectively Examples 7 and 8) show photographs for LCY and Solprene with 0.1% X-23002 morpholine disulfide crosslinking agent and FIGS. 7a and 7b (respectively Examples 9 and 10) with 0.2% crosslinking agent. As can be seen, the blends with the SBS polymers alone without crosslinking agent are incompatible with Cold Lake RAF, whereas the blends with crosslinking additive are all compatible. There are some differences in final S.P., but generally the tests show that LCY and Solprene SBS products perform similarly.

The results indicate that phase stable compositions are achieved with either 0.1 or 0.2% by weight crosslinker.

TABLE 2

| | | | | 2-day | |
|---|---|---|---|---|---|
| | | | | storage | Fluores- |
| | | | | stability | cence |
| Example | SBS | Crosslinker | S.P. | SP | Microscopy |
| No. | source | (wt. %) | ° C. | top/bottom | Compatible |
| 5 | LCY | — | 114.7 | 1.00 | No |
| 6 | Solprene | — | 116.6 | 1.09 | No |
| 7 | LCY | 0.1 | 118.1 | 1.01 | Yes |
| 8 | Solprene | 0.1 | 117.1 | 1.00 | Yes |
| 9 | LCY | 0.2 | 119.9 | 1.01 | Yes |
| 10 | Solprene | 0.2 | 115.3 | 0.99 | Yes |

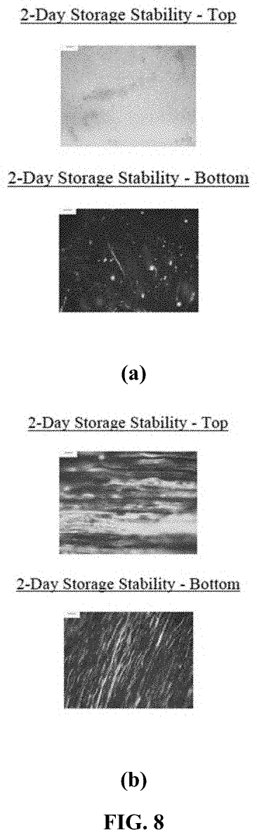

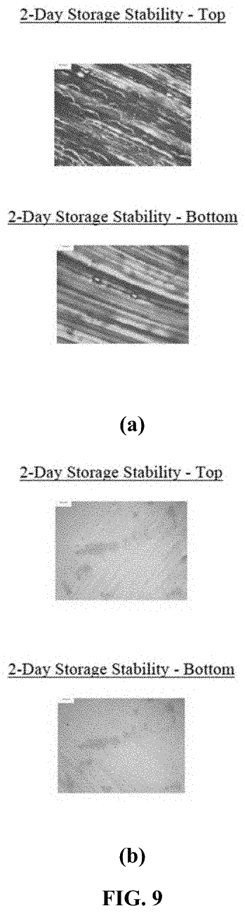

Table 3 shows the results for LCY SBS modified Cold Lake 150/200 and Cold Lake 300/400 asphalts (RAF) with and without 0.1% X-23002 morpholine disulfide. FIGS. 8a and 8b (respectively Examples 11 and 12) show the fluorescence microscope photographs for these blends with and without crosslinker, respectively, and FIGS. 9a and 9b (respectively Examples 13 and 14) show the 300/400 results with and without crosslinker. The repeat Cold Lake 300/400 (RAF) confirm those of SBS modified Cold Lake RAF in Table 2. Both the Cold Lake 150/200 and Cold Lake 300/400 data show that morpholine disulfide cross-linking does improve the compatibility of radial SBS and Cold Lake asphalt.

TABLE 3

| | | | | 2-day | |
|---|---|---|---|---|---|
| | | | | storage | Fluores- |
| | | | | stability | cence |
| Example | Asphalt | Crosslinker | S.P. | SP | Microscopy |
| No. | source | (wt. %) | ° C. | top/bottom | Compatible |
| 11 | Coldlake | — | 123 | 1.58 | No |
| 12 | 150/200 | 0.1 | 123 | 1.12 | Borderline |
| 13 | Coldlake | — | 120 | 1.01 | Borderline |
| 14 | 300-400 | 0.1 | 119 | 1.00 | Yes |

An experiment was conducted to evaluate the comparative effectiveness of sulfur cross-linking as elemental sulfur with that of sulfur tied up in morpholine disulfide (MDS). Elemental sulfur will thermally degrade into shorter chain sulfur chains that react to cross-link the double-bonds within SBS. Sulfur was tested as AKROFORM SULFUR PM (80). This was tested against AKROCHEM ACCELERATOR R (morpholine disulfide; MDS) in a LCY SBS modified Cold Lake 200/300 asphalt. The results are shown in Table 4. It was found that elemental sulfur (Example 15) also provided a phase stable composition of high asphaltene asphalt.

TABLE 4

| | | | | 2-day | |
|---|---|---|---|---|---|
| | | | | storage | Fluores- |
| | | | | stability | cence |
| Example | Asphalt | Crosslinker | S.P. | SP | Microscopy |
| No. | source | (wt. %) | ° C. | top/bottom | Compatible |
| 15 | Coldlake | 0.1 sulfur | 118 | 1.04 | Yes |
| 16 | 200/300 | 0.1 MDS | 115 | 1.02 | Yes |

Table 5 contains data for experiments conducted with LCY SBS in Nanticoke PG 58-28 asphalt and X-23002 morpholine disulfide. All of the blends gave high S.P.'s of approximately 133° C. The additive was evaluated at two levels. First, it was tested at 0.1% (Example 18) by addition to the Nanticoke PG 58-28 prior to the SBS addition. This gave borderline compatibility. Then it was tested at 0.2% (Example 19) with addition prior to the SBS. This gave good compatibility. The X-23002 was re-tested but this time the SBS was added first followed by the additive at 0.2% (Example 20). This addition sequence gave good compatibility however, the blend was lumpy during the low shear mixing stage indicating that the blend had poor compatibility. These data indicate that the preferred addition of the cross-linking additive is prior to the SBS addition, probably because this order of addition creates more opportunity for the cross-linking sulfur atoms to react with the butadiene molecules to effect cross-linking.

TABLE 5

| | | | | 2-day | |
|---|---|---|---|---|---|
| | | | | storage | Fluores- |
| | | | | stability | cence |
| Example | | Crosslinker | S.P. | SP | Microscopy |
| No. | Crosslinker | (wt. %) | ° C. | top/bottom | Compatible |
| 17 | None | — | 124.7 | 1.01 | No |
| 18 | MDS | 0.1 | 132.4 | 1.02 | Borderline |
| 19 | MDS | 0.2 | 132.8 | 1.00 | Yes |
| 20 | MDS | 0.2 | 132.8 | 1.00 | Yes |

Table 6 contains data for experiments conducted with Luprene SBS in a blend of Nanticoke PG 58-28 asphalt, Nanticoke RAF and Hexlink 518 (a 50% active dispersion of sulfur in napthenic oil). The additive was evaluated at three levels. At 0.1% (Example 21), the blend was incompatible. At 0.14% (Example 22) and 0.2% (Example 23), good compatibility was achieved. The results in Table 6 indicate that a compatible blend can be prepared using a crosslinker suspended in hydrocarbon oil using similar additive concentrations to when elemental sulfur or MDS are used while having a lower percentage of active component.

TABLE 6

| | | | 2-day | |
|---|---|---|---|---|
| | | | storage | Fluores- |
| | | | stability | cence |
| Example | Crosslinker | S.P. | SP | Microscopy |
| No. | (wt. %) | ° C. | top/bottom | Compatible |
| 21 | 0.1 | 114.0 | 1.03 | No |
| 22 | 0.14 | 120.3 | 0.99 | Yes |
| 23 | 0.2 | 118.2 | 1.03 | Yes |

Other crosslinking additives tested and which also provided phase stable compositions comprising SBS polymers and high asphaltene content asphalts include tetraethyl thiuram disulphide and N, N, N′, N′-tetraisobutyl thiuram disulphide.

The contents of all references, and published patents and patent applications cited throughout the application are hereby incorporated by reference.

It is understood that the detailed examples and embodiments described herein are given by way of example for illustrative purposes only, and are in no way considered to be limiting to the disclosure. Various modifications or changes in light thereof will be suggested to persons skilled in the art and are included within the spirit and purview of this application and are considered within the scope of the appended claims. For example, the relative quantities of the ingredients may be varied to optimize the desired effects, additional ingredients may be added, and/or similar ingredients may be substituted for one or more of the ingredients described. Additional advantageous features and functionalities associated with the systems, methods, and processes of the present disclosure will be apparent from the appended claims. Moreover, those skilled in the art will recognize, or be able to ascertain using no more than routine experimentation, many equivalents to the specific embodiments of the disclosure described herein. Such equivalents are intended to be encompassed by the following claims.

1. A phase stable polymer-asphalt composition, said composition comprising one or more styrenic block copolymers, one or more asphalts, and one or more crosslinking agents, wherein the one or more asphalts has a total asphaltene content of greater than or equal to about 12% by weight.

2. A phase stable polymer-asphalt composition according to claim 1, wherein the phase stable polymer-asphalt composition comprises 75 to 99% by weight of one or more asphalts, 1 to 20% by weight of one or more styrenic block copolymers and about 0.01 to about 1.0% by weight of one or more cross-linking agents.

3. A phase stable polymer-asphalt composition according to claim 1, wherein the crosslinking agent is present in an amount from about 0.01 to about 0.5% by weight based on the total weight of the composition.

4. A phase stable polymer-asphalt composition according to claim 1, wherein the total asphaltene content of the one or more asphalts is greater than or equal to about 15% by weight.

5. A phase stable polymer-asphalt composition according to claim 1, wherein the total asphaltene content of the one or more asphalts is from about 12% by weight to about 25% by weight.

6. A phase stable polymer-asphalt composition according to claim 1, wherein the composition comprises from about 2% to about 15% by weight of the one or more styrenic block copolymers.

7. A phase stable polymer-asphalt composition according to claim 6, wherein the styrenic block copolymer (SBC) is selected from the group consisting of linear SBC, radial SBC, and mixtures thereof.

8. A phase stable polymer-asphalt composition according to claim 1, wherein the styrenic block copolymers comprise polystyrene blocks.

9. A phase stable polymer-asphalt composition according to claim 1, wherein the styrenic block copolymers comprise a polybutadiene block.

10. A phase stable polymer-asphalt composition according to claim 1, wherein the styrenic block copolymer comprises a styrene-butadiene-styrene (SBS) block co-polymer.

11. A phase stable polymer-asphalt composition according to claim 10, wherein the styrene content of the SBS copolymer is 25-40% by weight and the butadiene content is 60 to 80% by weight.

12. A phase stable polymer-asphalt composition according to claim 1, wherein the styrenic block copolymer (SBC) has a molecular weight from about 15,000 to about 550,000 Daltons.

13. A phase stable polymer-asphalt composition according to claim 1, wherein the crosslinking agent is an agent capable of crosslinking SBC copolymers.

14. A phase stable polymer-asphalt composition according to claim 1, wherein the crosslinking agent is selected from the group consisting of elemental sulfur, polysulfides, organic titanates, organic zirconates, a suspension of elemental sulfur in a hydrocarbon oil, a suspension of a disulfide in a hydrocarbon oil, a mixture of elemental sulfur and disulfide in a hydrocarbon oil, and mixtures thereof.

15. A phase stable polymer-asphalt composition according to claim 1, wherein the composition has a minimum softening point of 120° C.

16. A roofing composition comprising a phase stable polymer-asphalt composition according to claim 1 and one or more fillers.

17. A roofing composition according to claim 16, comprising 1 to 65% by weight filler.

18. A roofing composition according to claim 16, wherein the composition comprises about 5-10% by weight styrenic block copolymer, about 50-60% by weight asphalt and about 30-40% by weight filler.

19. A roofing composition according to claim 16, wherein the filler is selected from the group consisting of calcium carbonate, limestone, chalk, ground rubber and mixtures thereof.

20. A roofing composition according to claim 19, wherein the composition comprises about 5-10% by weight styrene-butadiene-styrene (SBS) block copolymer, about 50-60% by weight asphalt and about 30-40% by weight calcium carbonate filler.

21. A roofing membrane comprising a roofing composition according to claim 16 and a fabric substrate.

22. A roofing composition according to claim 21, wherein the fabric substrate is selected from the group consisting of felt, fiberglass, polyester and combinations thereof.

23. A method for preparing a phase-stable polymer-asphalt composition comprising one or more styrenic block copolymers, one or more asphalts and one or more cross-linking agents, wherein the one or more asphalts have a total asphaltene content of greater than about 12% by weight, said method comprising:
(a) combining the one or more asphalts and one or more cross-linking agents; and
(b) adding the one or more styrenic block copolymers to the combination formed in (a).

24. A method according to claim 23, wherein the one or more asphalts are combined with the one or more cross-linking agents at a temperature from about 130 to about 210° C.

25. A method according to claim 23, wherein after addition of the one or more styrenic block copolymers the resulting mixture is mixed under high shear at a temperature from about 160 to about 220° C.

26. A method according to claim 23, wherein after the high shear mixing, the mixture is further mixed under low shear at a temperature from about 130 to about 210° C.

27. A method for making a roofing membrane comprising coating and/or saturating a fabric substrate with a roofing composition according to claim 23.

28. The method according to claim 23, wherein the phase stable polymer-asphalt composition comprises 75 to 99% by weight of one or more asphalts, 1 to 20% by weight of one or more styrenic block copolymers and about 0.01 to about 1.0% by weight of one or more cross-linking agents.

29. The method according to claim 23, wherein the styrenic block copolymer (SBC) is selected from the group consisting of linear SBC, radial SBC, and mixtures thereof.

30. The method according to claim 23, wherein the styrenic block copolymers comprise polystyrene blocks.

31. The method according to claim 23, wherein the styrenic block copolymers comprise a polybutadiene block.

32. The method according to claim 23, wherein the styrenic block copolymer comprises a styrene-butadiene-styrene (SBS) block co-polymer.

33. The method according to claim 32, wherein the styrene content of the SBS copolymer is 25-40% by weight and the butadiene content is 60 to 80% by weight.

34. The method according to claim 23, wherein the styrenic block copolymer (SBC) has a molecular weight from about 15,000 to about 550,000 Daltons.

35. The method according to claim 23, wherein the crosslinking agent is selected from the group consisting of elemental sulfur, polysulfides, organic titanates, organic zirconates, a suspension of elemental sulfur in a hydrocarbon oil, a suspension of a disulfide in a hydrocarbon oil, a mixture of elemental sulfur and disulfide in a hydrocarbon oil, and mixtures thereof.
